(19) United States
(12) Patent Application Publication
(10) Pub. No.: US 2017/0208287 A1
(43) Pub. Date: Jul. 20, 2017

(54) DISPLAY APPARATUS INCLUDING LIGHTING BEZEL AND METHOD OF PROVIDING VISUAL FEEDBACK BY USING THE LIGHTING BEZEL

(71) Applicant: Samsung Electronics Co., Ltd., Gyeonggi-do (KR)

(72) Inventors: Hyuntaik LIM, Surrey (GB); Kyung-hoon LEE, Seoul (KR); Eun-hye KIM, Seoul (KR); Jong-hee SOHN, Seoul (KR)

(73) Assignee: Samsung Electronics., Ltd., Gyeonggi-do (KR)

(21) Appl. No.: 15/326,825

(22) PCT Filed: Jul. 22, 2015
(86) PCT No.: PCT/KR2015/007610

§ 371 Date: Jan. 17, 2017

(30) Foreign Application Priority Data
Sep. 2, 2014 (KR) 10-2014-0116372

(51) Int. Cl. H04N 5/44; H04N 5/655; H04N 5/57

(52) U.S. Cl. CPC H04N 5/4403; H04N 5/57; H04N 5/655; H04N 2005/4408; H04N 2005/443; H04N 2005/4412

(57) ABSTRACT

A display apparatus includes a display unit configured to display a screen; a bezel formed along a boundary of the display unit and configured to output light; and a control unit configured to control lighting of the bezel, wherein the control unit is further configured to control a lighting area of the bezel to provide visual feedback corresponding to a status of the display apparatus to a user.

### TECHNICAL FIELD

One or more exemplary embodiments relate to a display apparatus including a lighting bezel and a method of providing visual feedback by using the lighting bezel.

### BACKGROUND ART

Nowadays, interests in methods of improving user's convenience and feeling by providing an electrode device having not only a functional performance but also being capable of improving user experience have increased.

Such a method may be implemented in various ways according to the characteristics of each device. For example, if feedback is provided in such a way that a user may more efficiently visually recognize a device status or a graphic user interface (GUI) displayed on a device screen, user's convenience and experience may be improved.

### DISCLOSURE OF INVENTION

### Technical Problem

One or more exemplary embodiments include providing a user with visual feedback by operating a bezel of a display apparatus to output light in patterns corresponding to various statuses of the display apparatus.

### Solution to Problem

According to one or more exemplary embodiments, a display apparatus includes a display unit configured to display a screen; a bezel formed along a boundary of the display unit and configured to output light; and a control unit configured to control lighting of the bezel, wherein the control unit is further configured to control a lighting area of the bezel to provide visual feedback corresponding to a status of the display apparatus to a user.

### Advantageous Effects of Invention

According to the one or more of the above embodiments of the present inventive concept, a bezel of a display apparatus such as a TV is capable of outputting light, and lighting of the bezel is controlled according to a preset pattern of a status of the display apparatus, thereby providing a user with visual feedback.

### BRIEF DESCRIPTION OF DRAWINGS

FIG. 1 illustrates a display apparatus according to an exemplary embodiment;

FIGS. 2 though 3B are diagrams for explaining a cross-sectional structure of a display apparatus according to exemplary embodiments;

FIGS. 4A and 4B are diagrams illustrating a bezel that outputs light according to exemplary embodiments;

FIGS. 5A and 5B are diagrams illustrating a bezel that outputs light when a display apparatus is in a standby mode and then is powered on according to an exemplary embodiment;

FIGS. 6 through 8 are diagrams illustrating a bezel that outputs light when a display apparatus is powered on according to exemplary embodiments;

FIGS. 9A and 9B are diagrams illustrating a bezel that outputs light when one of content list on a graphic user interface (GUI) displayed on a display apparatus is selected and reproduced according to an exemplary embodiment;

FIGS. 10 through 13 are diagrams illustrating a bezel that outputs light when a notification is displayed on a display apparatus according to an exemplary embodiment;

FIGS. 14A through 14C are diagrams illustrating a bezel that outputs light according to a search direction of a menu list on a GUI displayed on a display apparatus according to an exemplary embodiment;

FIGS. 15A and 15B are diagrams illustrating bezels that outputs light when an additional service related to content reproduced in a display apparatus is displayed on an auxiliary display apparatus according to an exemplary embodiment;

FIGS. 16 through 19 are flowcharts explaining a method of providing visual feedback via a lighting bezel of a display apparatus according to exemplary embodiments; and

FIG. 20 is a block diagram of a display apparatus according to an exemplary embodiment.

### BEST MODE FOR CARRYING OUT THE INVENTION

According to one or more exemplary embodiments, a display apparatus includes a display unit configured to display a screen; a bezel formed along a boundary of the display unit and configured to output light; and a control unit configured to control lighting of the bezel, wherein the control unit is further configured to control a lighting area of the bezel to provide visual feedback corresponding to a status of the display apparatus to a user.

The control unit may be further configured to provide the visual feedback to the user by controlling the bezel to partially or wholly output light according to a preset pattern corresponding to each of various statuses of the display apparatus.

The control unit may be further configured to control the lighting of the bezel via a graphic user interface (GUI) displayed on the display unit or a user input received by the display apparatus.

The control unit may be further configured to control the bezel to output light in at least a part thereof when the display apparatus is in a standby mode and to extend the lighting area of the bezel if the display apparatus is powered on.

If content of a content list on a GUI displayed on the display unit is selected, the control unit may be further configured to control the bezel to output light at a position corresponding to the selected content.

If the selected content extends to an entire of the display unit and thus reproduction thereof starts, the control unit may be further configured to extend the lighting area of the bezel.

If a notification is displayed on the display unit, the control unit may be further configured to control the bezel to output light in at least a part thereof.

The control unit may be further configured to change the lighting of the bezel according to a status change of the displayed notification.

The control unit may be further configured to control the lighting of the bezel according to a search direction of a menu list on a GUI displayed on the display unit.

When an additional service related to content displayed on the display unit is displayed on an auxiliary display apparatus connected to the display apparatus, the control unit may be further configured to control corresponding areas of the bezel of the display apparatus and a bezel of the auxiliary display apparatus to output light.

The display unit may include a screen display area configured to generate light for a screen display; and a bezel lighting area configured to generate light for the bezel, wherein the bezel is formed of a transparent material and is configured to output light by reflecting and diffusing the light generated in the bezel lighting area.

According to one or more exemplary embodiments, a method of providing visual feedback via lighting of a bezel of a display apparatus includes: checking a status of the display apparatus; and controlling lighting of the bezel to provide the visual feedback corresponding to the checked status to a user.

The controlling of the lighting of the bezel may include: controlling the bezel to at least partially output light when the display apparatus is in a standby mode, and extending a lighting area of the bezel if the display apparatus is powered on.

The controlling of the lighting of the bezel may include: if content in a content list on a GUI displayed on the display unit is selected, controlling the bezel to output light at a position corresponding to the selected content.

The controlling of the lighting of the bezel may include: if the selected content extends to an entire screen of the display apparatus and thus reproduction thereof starts, extending a lighting area of the bezel.

The controlling of the lighting of the bezel may include: if a notification is displayed on the display unit, controlling the bezel to output light from at least a part thereof.

The controlling of the lighting of the bezel may include: changing the lighting of the bezel according to a status change of the displayed notification.

The controlling of the lighting of the bezel may include: controlling the lighting of the bezel according to a search direction of a menu list on a GUI displayed on the display unit.

The controlling of the lighting of the bezel may include: when an additional service related to content displayed on the display unit is displayed on an auxiliary display apparatus connected to the display apparatus, controlling corresponding areas of bezels of the display apparatus and the auxiliary display apparatus to output light.

### MODE FOR THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

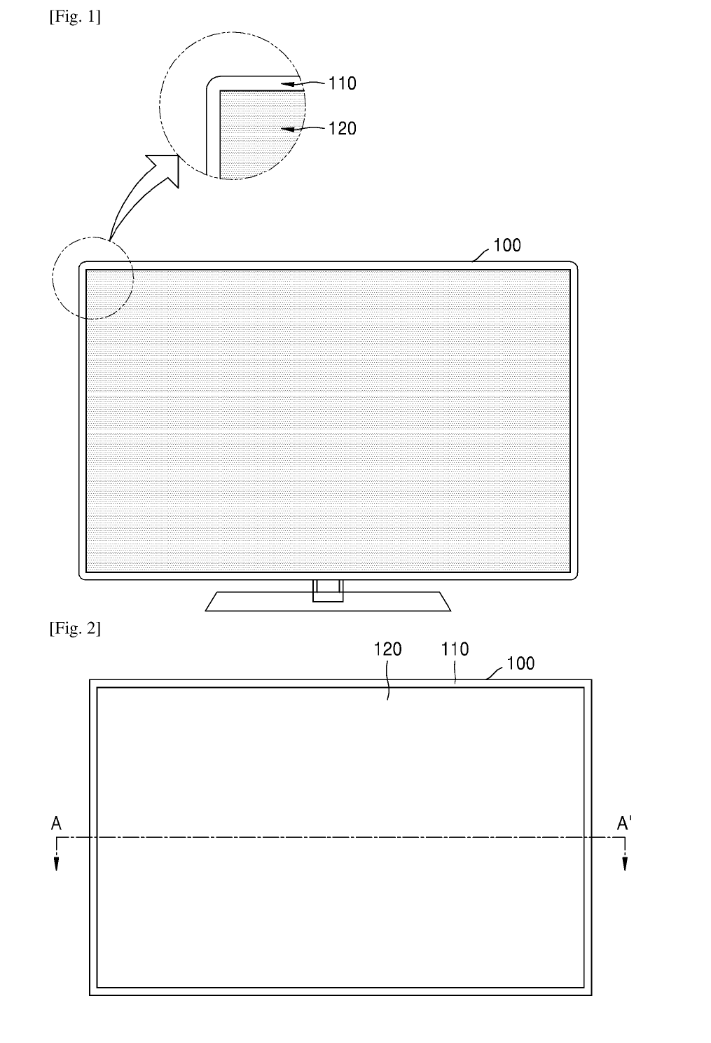

FIG. 1 illustrates a display apparatus 100 according to an exemplary embodiment. Referring to FIG. 1, the display apparatus 100 according to an exemplary embodiment may include a bezel 110 and a display unit 120. The display apparatus 100 may be a TV, a smart phone, or a tablet.

A screen is displayed on the display unit 120. The display unit 120 may be a liquid crystal display (LCD) panel or an organic light emitting diode (OLED) display panel, but the exemplary embodiment is not limited thereto. Thus, the display unit 120 may be a display panel of various types.

The bezel 110 corresponds to a front surface of a part connecting the display unit 120 and a main body frame of the display apparatus 100, and as shown in FIG. 1, may be formed along a boundary of the display unit 120. A material of the bezel 110 may be acryl or polycarbonate.

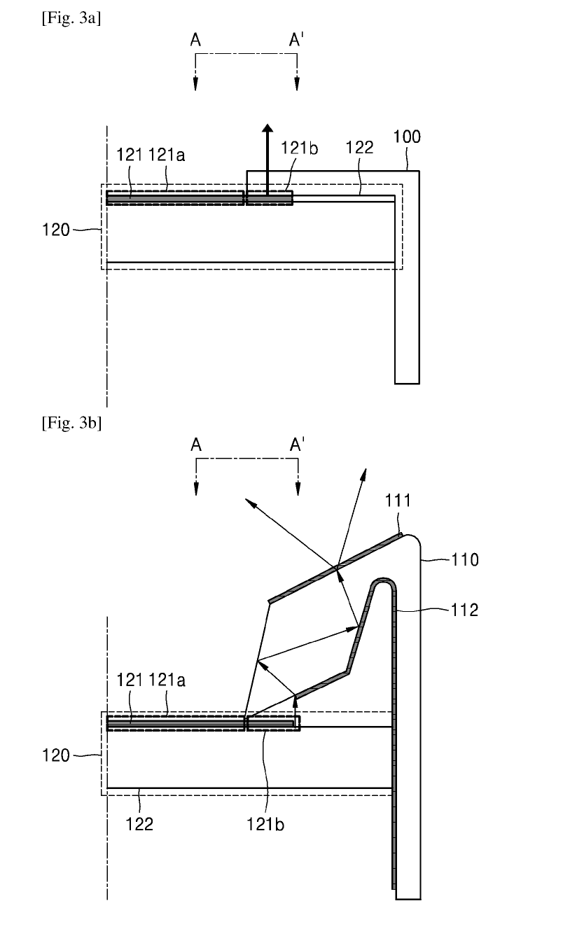

In particular, the bezel 110 of the display apparatus 100 according to an exemplary embodiment is operable to output light. The bezel 110 may output light by providing a light source therein or by forming the bezel 110 of a transparent material and allowing light generated from a light source provided at the back thereof to pass though the transparent material. In particular, the bezel 110 may output light via reflection and diffusion of light generated in some pixels of a display panel of the display unit 120. In addition, a type of the bezel 110 capable of outputting light may be implemented in various ways. Embodiments of detailed structures of the bezel 110 will be described with reference to FIGS. 2 through 3B.

The display apparatus 100 according to an exemplary embodiment may provide visual feedback corresponding to a status of the display apparatus 100 to a user by controlling lighting of the bezel 110. The visual feedback means lighting of the bezel 110 such that the user may recognize the status of the display apparatus 100.

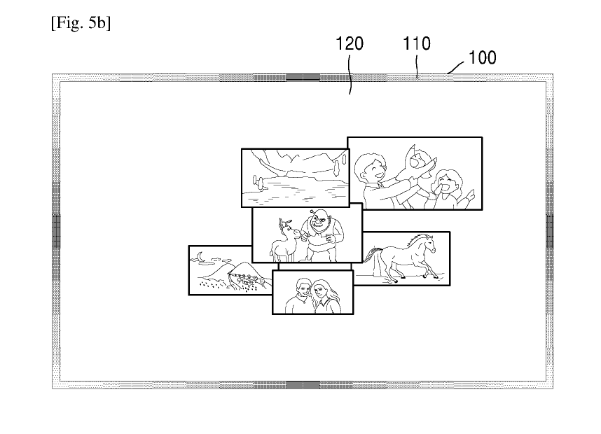

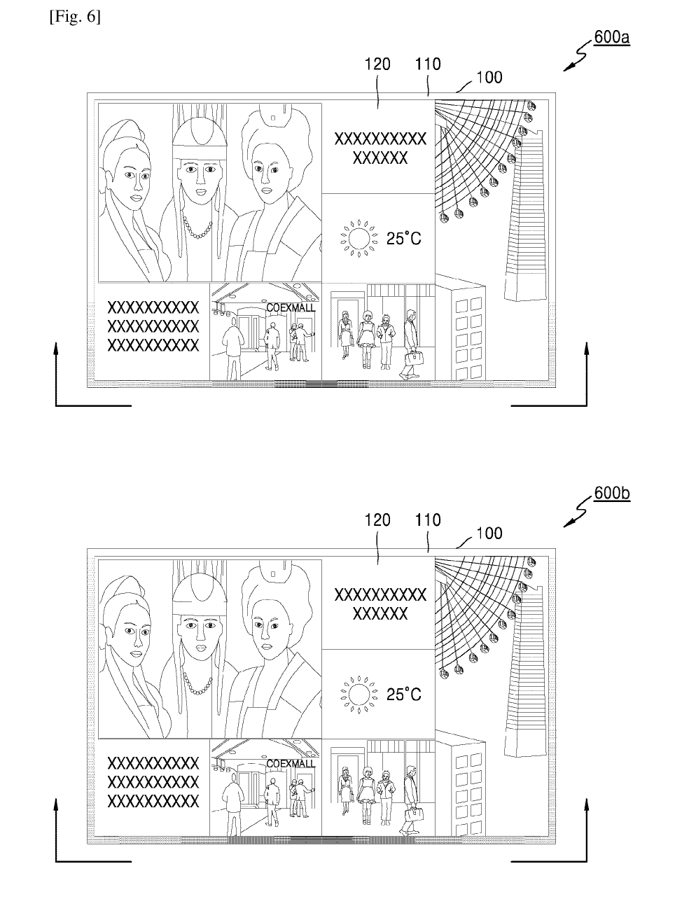

To this end, the display apparatus 100 may provide the visual feedback to the user by partially or wholly lighting the bezel 110 according to a preset pattern corresponding to each of various statuses of the display apparatus 100. For example, the display apparatus 100 may control lighting of the bezel 110 via a graphic user interface (GUI) displayed on the display unit 120 or a user input received by the display apparatus 100. Detailed embodiments of providing the visual feedback to the user by controlling lighting of the bezel 110 will be described in detail with reference to FIGS. 5A through 16B.

FIGS. 2 though 3B are diagrams for explaining a cross-sectional structure of the display apparatus 100 according to exemplary embodiments. In more detail, FIG. 2 illustrates a front surface of the display apparatus 100 according to an exemplary embodiment, and FIGS. 3A and 3B are partial cross-sectional views of the display apparatus 100 taken along a line A-A′ according other embodiments.

The display apparatus 100 of FIG. 2 includes the bezel 110 and the display unit 120 as described with reference to FIG. 1 above.

Referring to FIG. 3A, the display unit 120 includes an active area 121 and a panel 122. The active area 121 is an area including pixels that substantially generate light. The panel 122 is a part supporting the active area 121.

The active area 121 may be divided into a screen display area 121a and a bezel lighting area 121b. The screen display area 121a is an area on which a screen such as content generated by the display apparatus 100 is displayed. The bezel lighting area 121b is an area for controlling lighting of the bezel 110. For example, since an OLED display is capable of independent control for each pixel, pixels included in the screen display area 121a and the bezel lighting area 121b may be independently controlled. Thus, the screen such as content generated by the display apparatus 100 may be displayed on the screen display area 121a, and at the same time, light for lighting of the bezel 110 may be generated in the bezel lighting area 121b.

According to the embodiment of FIG. 3A as described above, the bezel 110 may light by controlling some pixels included in the active area 121 of the display unit 120 without having a light source for lighting of the bezel 110.

Meanwhile, a modified structure of the bezel 110 is illustrated in FIG. 3B compared to FIG. A. Referring to FIG. 3B, the display unit 120 includes the active area 121 and the panel 122. The active area 121 is divided into the screen display area 121a and the bezel lighting area 121b, of which descriptions are the same as described with reference to FIG. 3A above.

The bezel 110 of FIG. 3B has a curved shape. Light that has passed through the bezel 110 is refracted, reflected, and diffused in the inside of the bezel 110 and then is output to the outside. To reflect and diffuse the light, diffusing coating 111 and reflective coating 112 may be formed on a surface of the bezel 110. Alternatively, although the diffusing coating 111 and the reflective coating 112 are not formed on the bezel 110, the light is totally reflected in the bezel 110, and thus the bezel 110 may output light.

Referring to FIG. 3B, the light generated from the bezel lighting area 121b is incident on and refracted by a surface of the bezel 110, travels through the bezel 110, is reflected by the reflective coating 112, is diffused through the diffusing coating 111, and is output to the outside of the bezel 110.

Meanwhile, in addition to the embodiments of FIGS. 3A and 3B, a structure of the bezel 110 may be implemented in various ways.

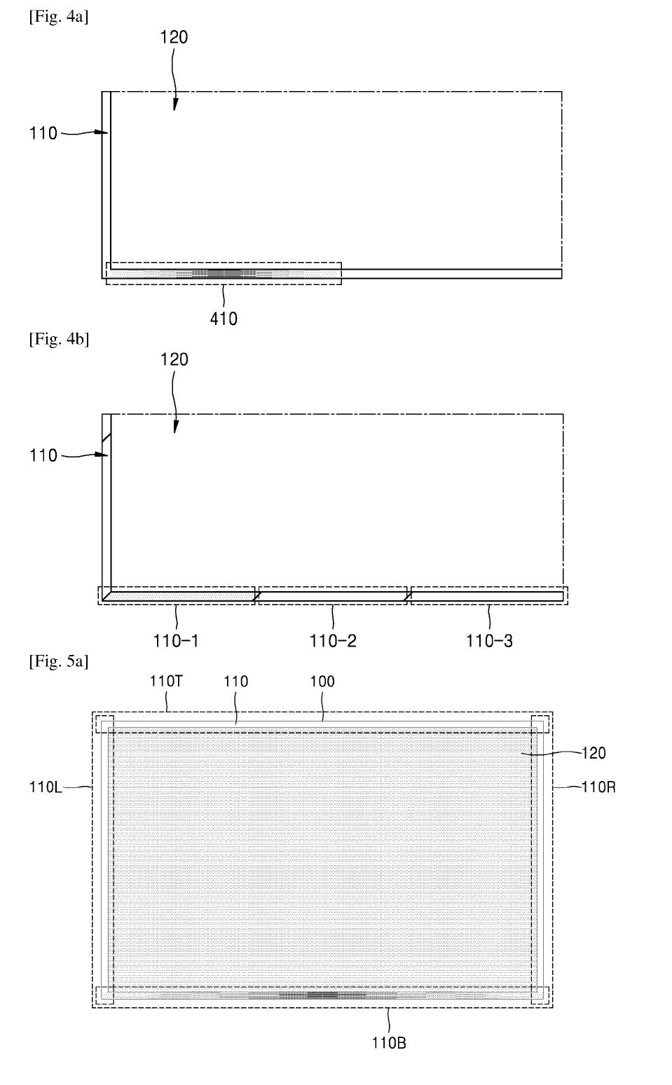

FIGS. 4A and 4B are diagrams illustrating the bezel 110 that lights according to exemplary embodiments. The bezel 110 may output light in various ways. For example, as shown in FIG. 4A, a gradation process may be performed such that as an edge of a lighting area 410 is closer to a center portion thereof, the lighting color slowly becomes brighter. The lighting area 410 is able to continuously expand or shrink.

Alternatively, as shown in FIG. 4B, the bezel 110 is divided into a first area 110-1, a second area 110-2, and a third area 110-3, and may output light in each divided area unit.

Meanwhile, in addition to the embodiments of FIGS. 4A and 4B, lighting of the bezel 110 may be implemented in various ways.

Detailed embodiments of providing a user with visual feedback through lighting of the bezel 110 will be described below with reference to FIGS. 5A through 15B.

FIGS. 5A and 5B are diagrams illustrating the bezel 110 that lights when the display apparatus 100 is in a standby mode and then is powered on according to an exemplary embodiment.

Referring to FIG. 5A, when the display apparatus 100 enters the standby mode, no screen is displayed on the display unit 120. The standby mode is a mode wherein a minimum amount of power is supplied to the display apparatus 100 in order to reduce power consumption. Although the display apparatus 100 is in the standby mode, the display apparatus 100 may prepare for reproduction of content or a user service.

A status in which the display apparatus 100 is in the standby mode may be distinguished from a status in which the display apparatus 100 is completely powered off by lighting a part of the bezel 110 when the display apparatus 100 enters into the standby mode. Although only a bottom end 110B of the bezel 110 lights in FIG. 5A, the bezel 110 may light in various patterns like at least one of a top end 110T, a left end 110L, and a right end 110R may light.

Meanwhile, the bezel 110 does not light when the display apparatus 100 is merely in the standby mode, whereas the bezel 110 may light when the reproduction of content or the user service is prepared in the standby mode. Alternatively, when the display apparatus 100 is in the standby mode, the bezel 110 may light, and, if the reproduction of content or the user service is prepared in the standby mode, an area or a pattern in which the bezel 110 lights may be different.

If the display apparatus 100 is powered on in the standby mode, as shown in FIG. 5B, a screen may be displayed on the display unit 120 so that the bezel 110 may wholly light. When the display apparatus 100 is powered on, the bezel 110 may light in various patterns, which will be described in detail with reference to FIGS. 6 through 8 below.

FIGS. 6 through 8 are diagrams illustrating the bezel 110 that outputs light when the display apparatus 100 is powered on according to exemplary embodiments.

FIG. 6 sequentially illustrates lighting patterns of the bezel 110 as a first status 600a and a second status 600b over time after the display apparatus 100 is powered on. Referring to FIG. 6, if the display apparatus 100 is powered on, the bezel 110 starts to output lighting from a bottom end, like the first status 600a, and gradually extends lighting upward. In the second status 600b after a predetermined period of time from the first status 600a, the lighting area of the bezel 110 may extend upward. If time further elapses in the second status 600b, the lighting area extends so that the bezel 110 may completely light.

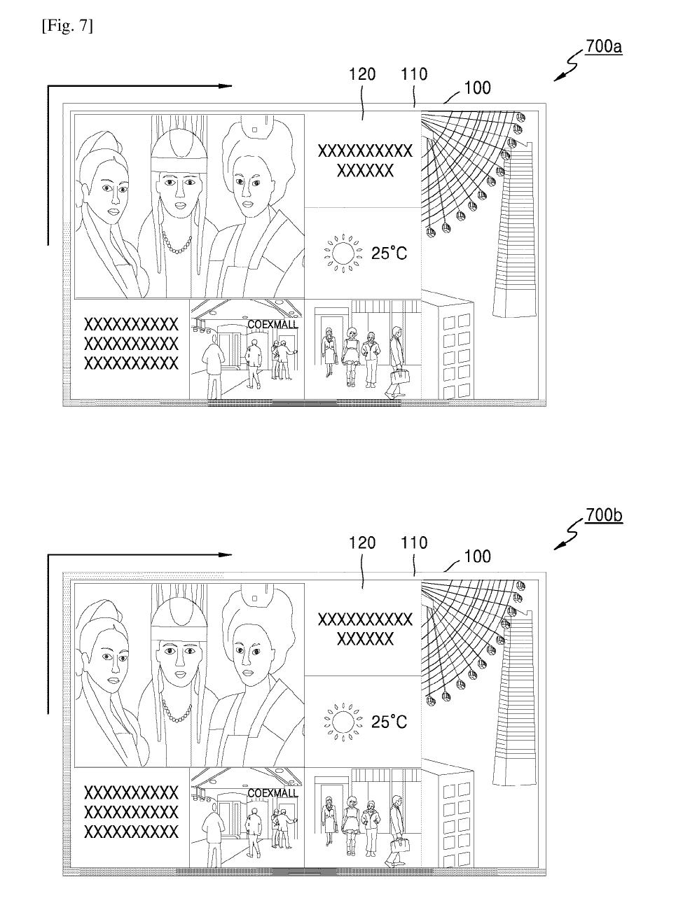

FIG. 7 sequentially illustrates lighting patterns of the bezel 110 as a first status 700a and a second status 700b over time after the display apparatus 100 is powered on. Referring to FIG. 7, if the display apparatus 100 is powered on, the bezel 110 may start lighting from a bottom end and gradually extend the lighting area clockwise from the first status 700a to the second status 700b.

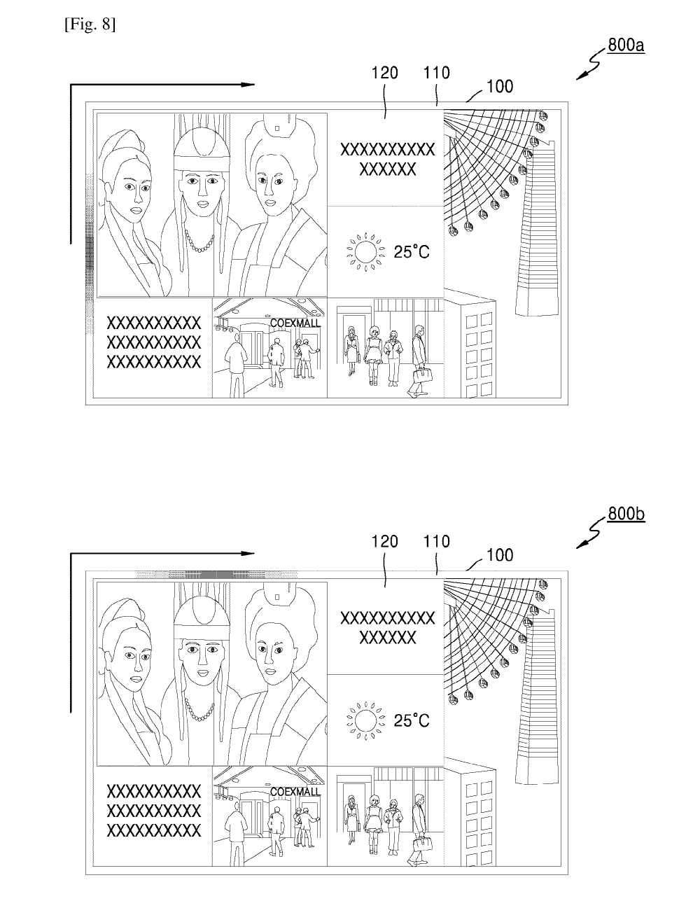

FIG. 8 sequentially illustrates lighting patterns of the bezel 110 as a first status 800a and a second status 800b over time after the display apparatus 100 is powered on. Referring to FIG. 8, if the display apparatus 100 is powered on, the bezel 110 may gradually move the lighting area clockwise from the first status 800a to the second status 800b.

Meanwhile, the lighting patterns of the bezel 110 when the display apparatus 100 is powered on may be implemented in various ways in addition to those described above.

A user may more promptly and intuitively recognize that the display apparatus 100 is powered on by seeing the bezel 100 that outputs light. In particular, if the user sees the display apparatus 100 more than several seconds, the display apparatus 100 may be implemented to be powered on. In this case, it is useful to provide visual feedback that the display apparatus 100 is powered on through the lighting of the bezel 110.

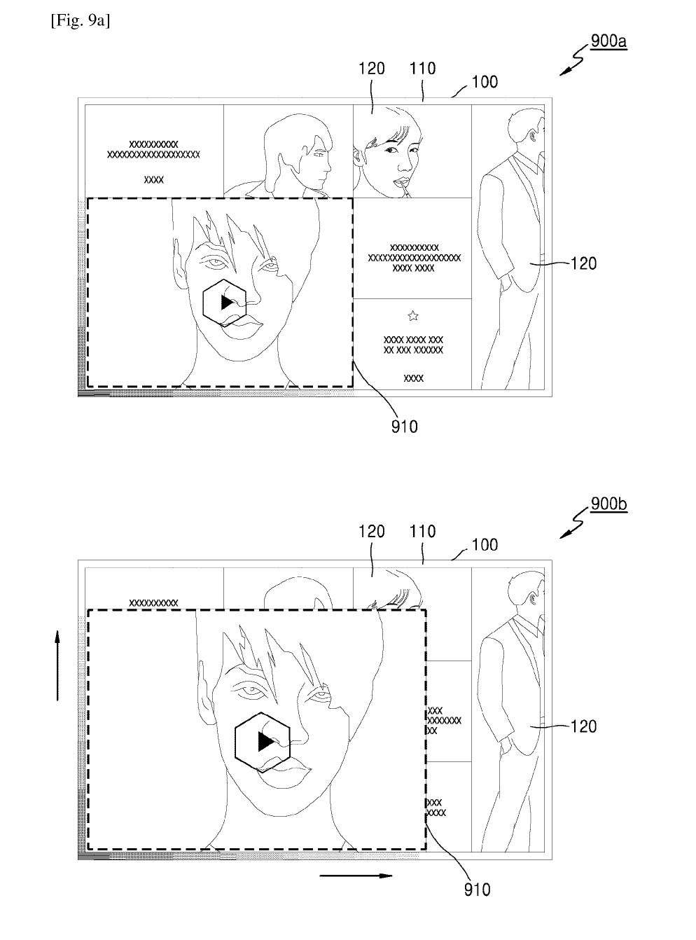

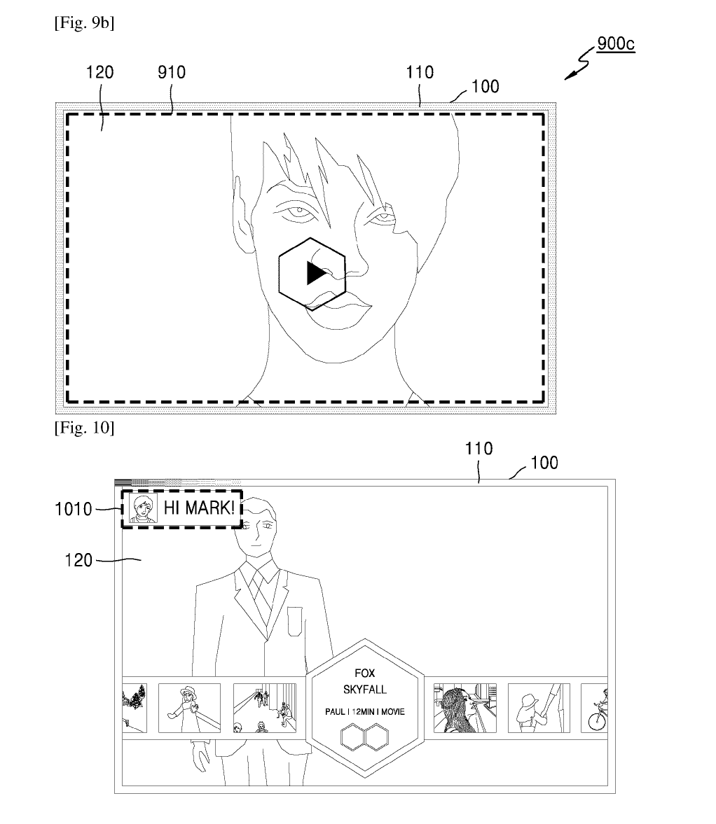

FIGS. 9A and 9B are diagrams illustrating the bezel 110 that lights when one of content list on a graphic user interface (GUI) displayed on the display apparatus 100 is selected and reproduced according to an exemplary embodiment.

Referring to FIG. 9A, the GUI including the content list is displayed on the display unit 120 of the display apparatus 100 in a first status 900a. If it is being prepared to select and reproduce one of the content list on the GUI in the first status 900a as shown, the bezel 110 in a position corresponding to selected content 910 lights. In the first status 900a, the bezel 110 of an area adjacent to the selected content 910 lights. In this regard, the position of the bezel 110 corresponding to the selected content 910 may be differently set. For example, the bezel 110 of areas positioned in upper and lower portions of the selected content 910 may light, or the bezel 110 of areas positioned in left and right portions of the selected content 910 may light.

If reproduction of the selected content 910 starts, the content 910 gradually extends to the entire of the display unit 120 in the second status 900b as shown. In this regard, as the content 910 extends, a lighting area of the bezel 110 also extends.

Referring to FIG. 9B, when the content 910 extends to an entire screen in a third status 900c, the bezel 100 wholly outputs light.

FIGS. 10 through 13 are diagrams illustrating the bezel 110 that output light when a notification is displayed on the display apparatus 100 according to an exemplary embodiment.

Referring to FIG. 10, if a user logs in the display apparatus 100, a login notification 1010 is displayed on the display unit 120. If the login notification 1010 is displayed on the display unit 120, the bezel 110 of an area adjacent to the login notification 1010 lights. Thus, the user may more intuitively recognize that login is successfully completed through lighting of the bezel 110. In this regard, a lighting area and pattern of the bezel 110 may be set in various ways.

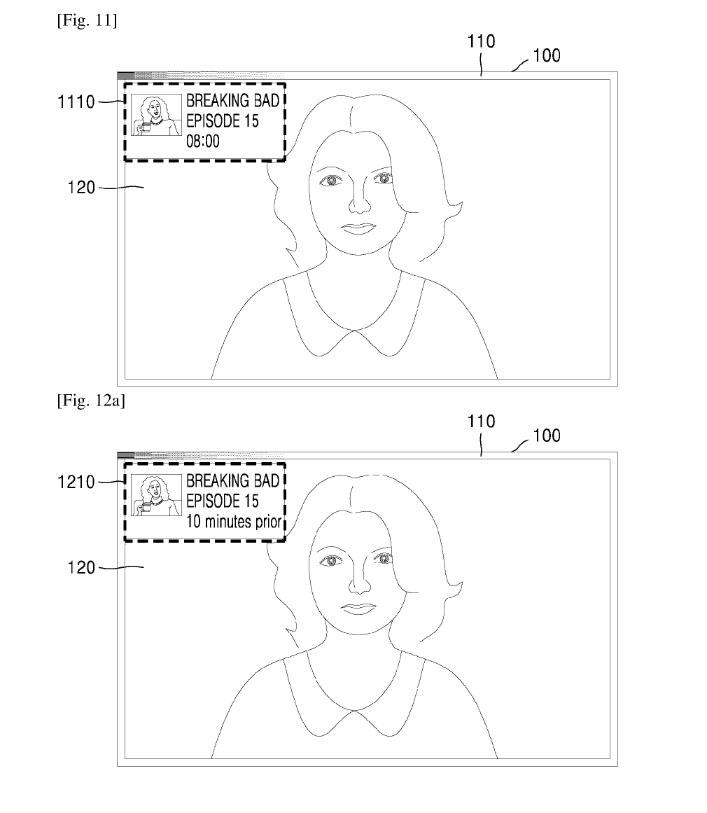

Referring to FIG. 11, if a program is scheduled to be watched on the display apparatus 100, a watch scheduling notification 1110 is displayed on the display unit 120 approaching a start time of the scheduled program. A title of the program, the start time thereof, and a still cut image thereof may be included in the watch scheduling notification 1110 as shown in FIG. 11. If the watch scheduling notification 1110 is displayed on the display unit 120, the bezel 110 of an area adjacent to the watch scheduling notification 1110 outputs light. Thus, the user may more intuitively recognize a guide for the schedule program through lighting of the bezel 110. In this regard, a light position and pattern of the bezel 110 may be set in various ways.

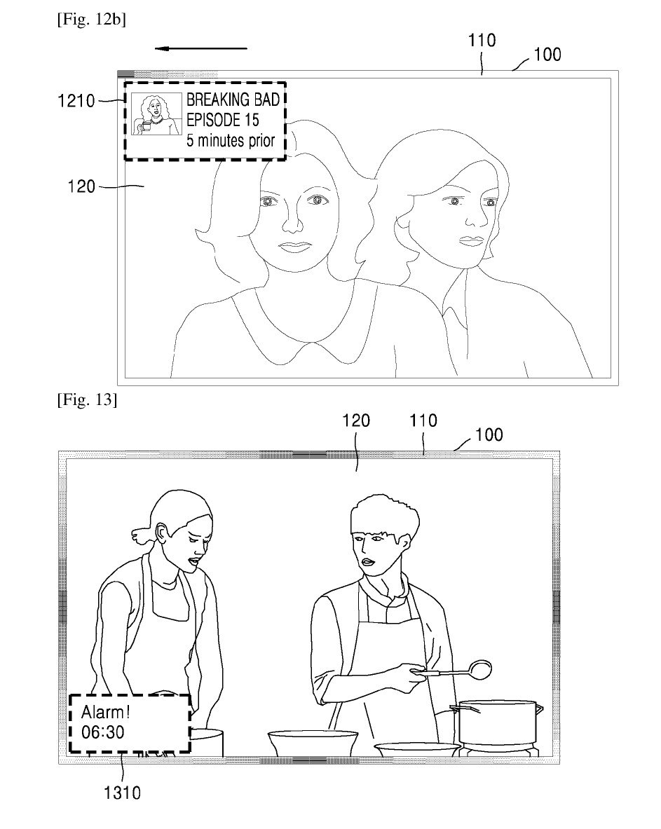

Meanwhile, the bezel 110 may be implemented so that lighting thereof may change according to a change in a status of a notification, which will be described with reference to FIGS. 12A and 12B below.

Referring to FIG. 12A, if a program is scheduled to be watched on the display apparatus 100, a watch scheduling notification 1210 is displayed on the display unit 120 approaching a start time of the scheduled program. A title of the program, time left until the start thereof, and a still cut image thereof may be included in the watch scheduling notification 1210 as shown in FIG. 12A. If the watch scheduling notification 1210 is displayed on the display unit 120, the bezel 110 of an area adjacent to the watch scheduling notification 1210 output light.

Lighting of the bezel 110 changes according to a change in a status of the watch scheduling notification 1210. In more detail, since the left time displayed on the watch scheduling notification 1210 is reduced, a lighting area of the bezel 110 is reduced. Referring to FIGS. 12A and 12B, since the left time of the watch scheduling notification 1210 is reduced from 10 minutes to 5 minutes, the lighting area of the bezel 110 may be also reduced to the half. As described above, a user may more intuitively recognize a notification status change by changing the lighting of the bezel 110 according to the notification status change. In this regard, a light position and pattern of the bezel 110 may be set in various ways.

Referring to FIG. 13, when an alarm is set in the display apparatus 100, an alarm notification 1310 is displayed on the display unit 120. If the alarm notification 1310 is displayed on the display unit 120, the bezel 110 wholly outputs light. Thus, a user may more intuitively recognize that it is a time for the set alarm through lighting of the bezel 110. In this regard, a light position and pattern of the bezel 110 may be set in various ways.

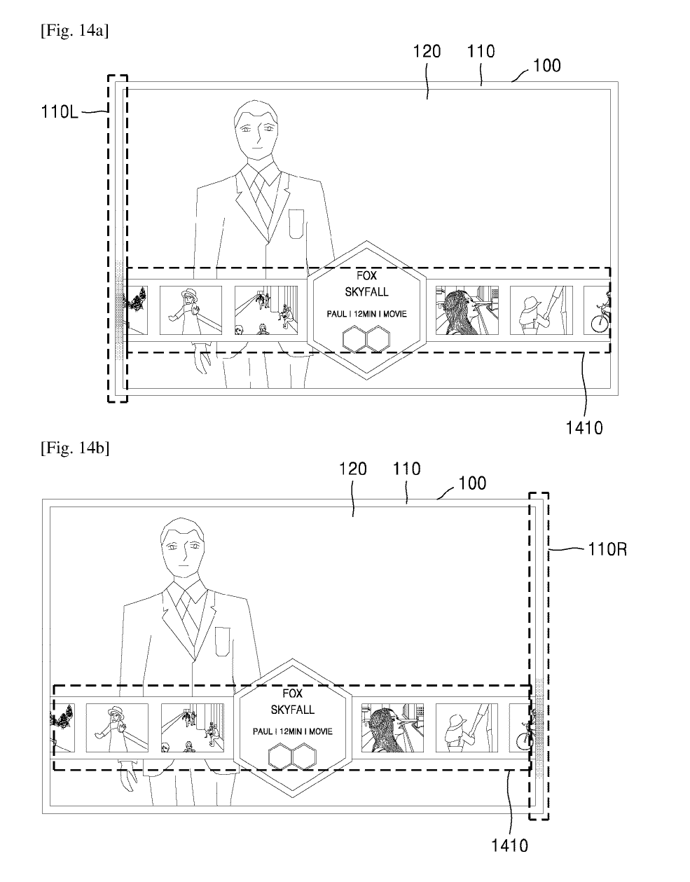

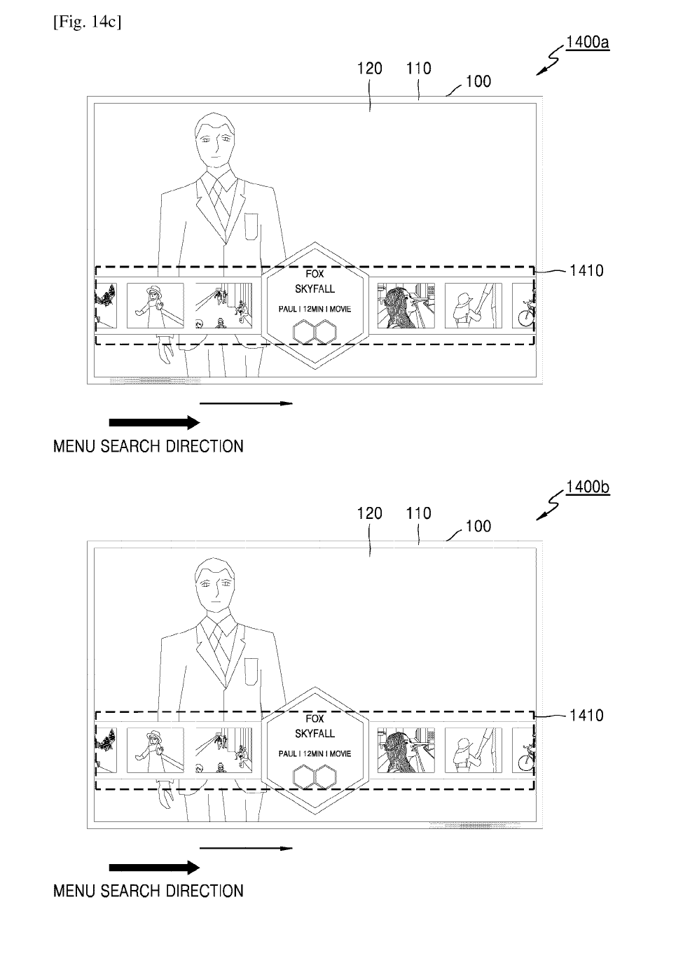

FIGS. 14A through 14C are diagrams illustrating the bezel 110 that outputs light according to a search direction of a menu list 1410 on a GUI displayed on the display apparatus 100 according to an exemplary embodiment. The GUI including the menu list 1410 may be displayed. If a user searches for the menu list 1410, the left end 110L of the bezel 110 in a direction in which the menu list 1410 comes out lights. The user may intuitively recognize a direction in which the user is currently searching for the menu list 140 through the bezel 110 that lights.

Meanwhile, to the contrary of the embodiment of FIG. 14A, the bezel 110 may output light in an area of a direction in which the menu list 1410 comes in in FIG. 14B. Referring to FIG. 14B, if the user searches the menu list 1410, the right end 110R of the bezel 110 may output light in the direction in which the menu list 1401 comes in.

A lighting area of the bezel 110 moves in a search direction of the menu list 1410 in FIG. 14C. Referring to FIG. 14C, if the user searches for the menu list 1410 from left to right like an arrow direction shown in FIG. 14C, the lighting area of the bezel 110 moves from left to right from a first status 1400a to a second status 1400b.

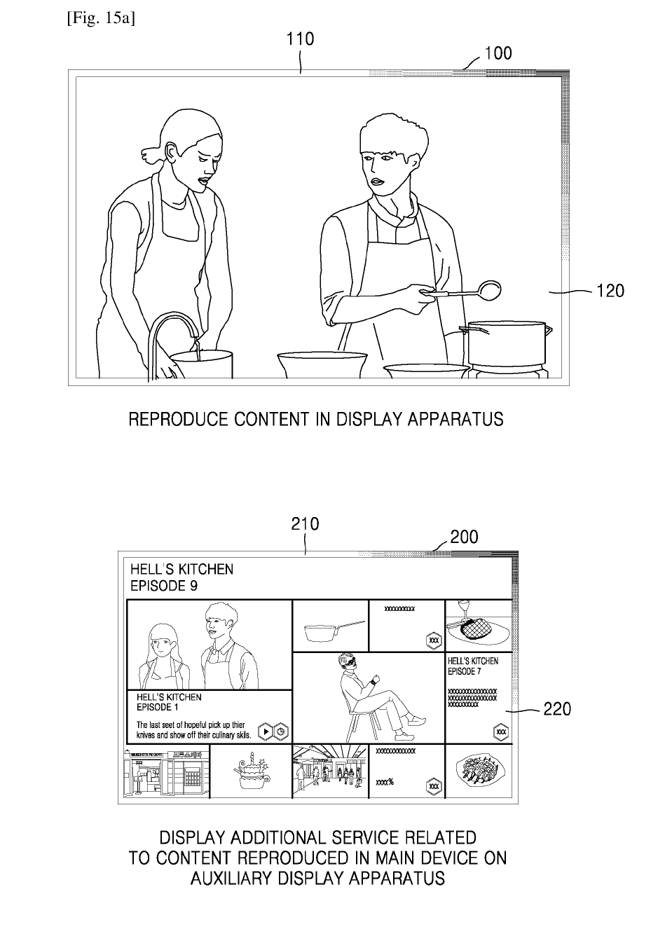

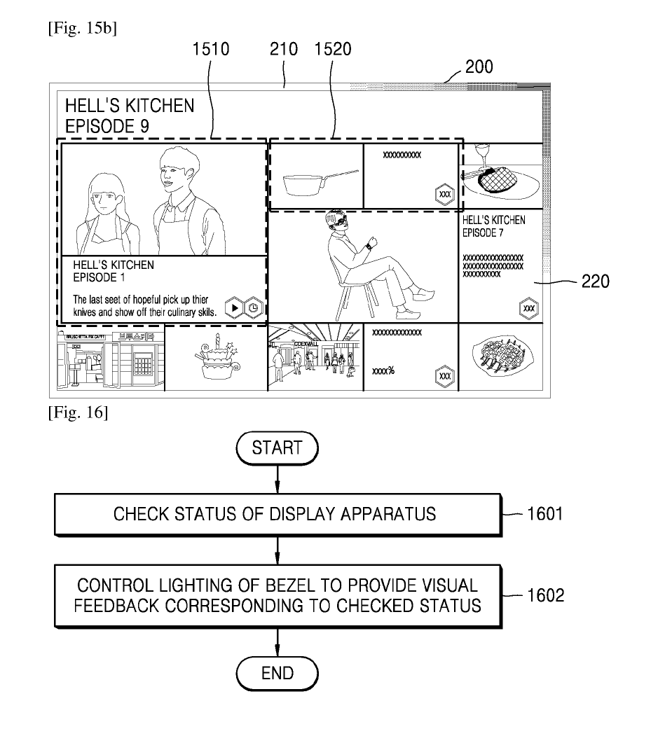

FIGS. 15A and 15B are diagrams illustrating the bezel 110 and a bezel 210 that light when an additional service related to content reproduced in the display apparatus 100 is displayed on an auxiliary display apparatus 200 according to an exemplary embodiment.

Referring to FIG. 15A, a content reproduction screen is displayed on the display unit 120 of the display apparatus 100. An additional service screen related to the content reproduced in the display apparatus 100 is displayed on a display unit 220 of the auxiliary display apparatus 200. In this regard, the auxiliary display apparatus 200 may be a TV, a smart phone, or a table.

As described above, when the display apparatus 100 and the auxiliary display apparatus 200 display screens that are linked and related to each other, the bezels 110 and 210 of the display apparatus 100 and the auxiliary display apparatus 200 light correspond areas. Referring to FIG. 15A, a right top corner portion of the bezel 110 of the display apparatus 100 lights, and a right top corner portion of the bezel 210 of the display apparatus 200 correspondingly lights. Thus, a user may intuitively recognize that the display apparatus 100 and the auxiliary display apparatus 200 display the screens that are linked and related to each other.

Meanwhile, although the auxiliary display apparatus 200 includes the lighting bezel 210 in FIG. 15A, if the auxiliary display apparatus 200 does not include the lighting bezel 210, a certain portion of the display unit 220 corresponding to the lighting of the bezel 110 of the display apparatus 100 may be displayed. For example, if the bezel 110 of a right corner portion of the display apparatus 100 lights as shown in FIG. 15A, a right corner portion of the display unit 220 of the auxiliary display apparatus 200 may be displayed as a lighting color of the bezel 110.

FIG. 15B illustrates in more detail the additional service screen displayed on the auxiliary display apparatus 200. Referring to FIG. 15B, the additional service screen related to content may display a list 1510 of other contents related to the content or a web site 1520 used to purchase an article appearing on the content.

FIGS. 16 through 19 are flowcharts explaining a visual feedback providing method using a lighting bezel of a display apparatus according to exemplary embodiments.

Referring to FIG. 16, in operation S1601, a status of the display apparatus is checked. In operation S1602, lighting of a bezel is controlled to provide visual feedback corresponding to the checked status of the display apparatus.

In this regard, the status of the display apparatus means a GUI display on a screen of the display apparatus or a user input received by the display apparatus. The display apparatus stores a preset lighting pattern of the bezel corresponding to various statuses, and checks a lighting pattern corresponding to the checked status, thereby controlling the lighting.

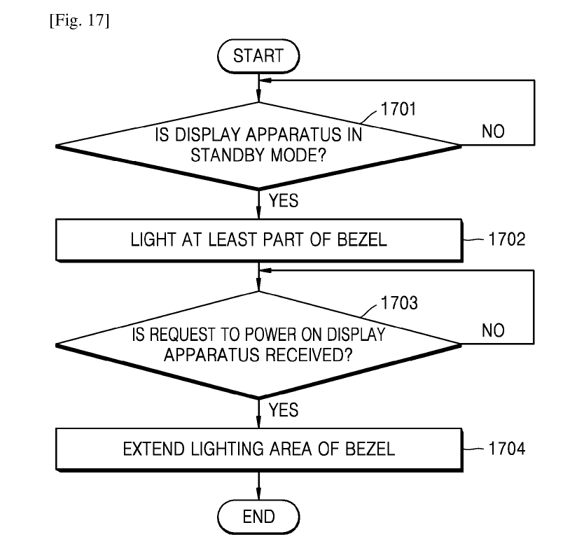

Meanwhile, detailed embodiments that the lighting of the bezel is controlled to provide visual feedback corresponding to various statuses of the display apparatus are the same as described with reference to FIGS. 5A through 15B and will be described in brief with reference to FIGS. 17 through 19 below.

Referring to FIG. 17, in operation 51701, it is determined whether the display apparatus is in a standby mode. As a result of determination, if the display apparatus is in the standby mode, the display apparatus lights at least a part of the bezel of the display apparatus in operation S1702.

In operation S1703, the display apparatus determines whether a power on request is received. As a result of determination, if the power on request is received, the display apparatus extends a lighting area of the bezel. In this regard, a method of extending the lighting area of the bezel may be implemented in various ways as described with reference to FIGS. 6 through 8 above.

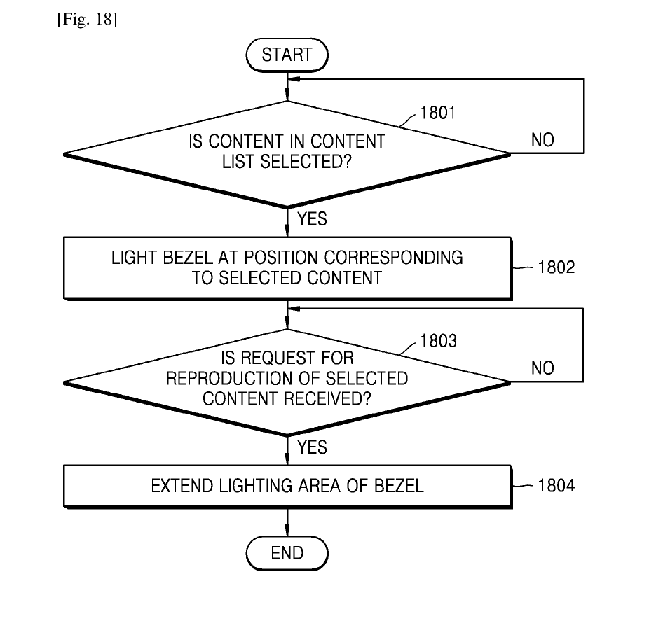

Referring to FIG. 18, in operation S1801, the display apparatus determines whether one is selected from a content list on a GUI displayed on a screen. As a result of determination, if content is selected from the content list, the bezel of the display apparatus outputs light at a position corresponding to the selected content in operation S1802. For example, as shown in FIG. 9A, the bezel of the display apparatus may output light at a corner portion adjacent to the selected content.

In operation S1803, the display apparatus determines whether a reproduction request of the selected content is received. As a result of determination, if the reproduction request is received, the display apparatus starts reproduction of the content and simultaneously extends a lighting area of the bezel in operation S1804. For example, as shown in FIGS. 9A and 9B, if reproduction of the selected content starts, a reproduction screen of the selected content gradually extends to an entire screen of the display apparatus, and thus the lighting area of the bezel may also extend.

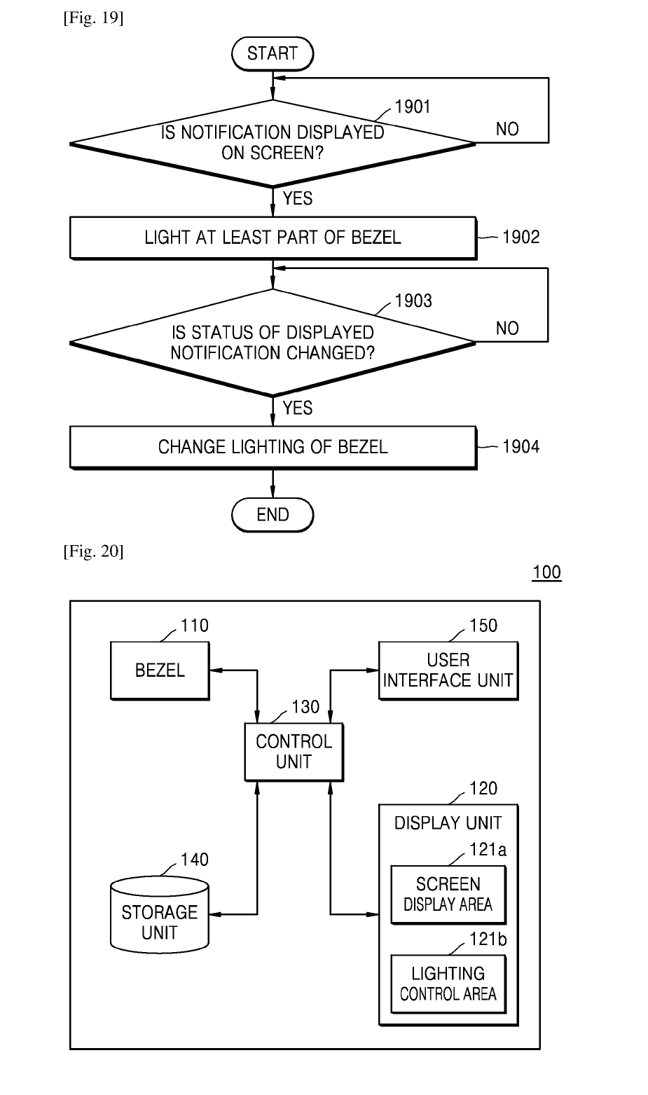

Referring to FIG. 19, in operation S1901, the display apparatus determines whether a notification is displayed on the screen. In this regard, the displayed notification may be a user login display, a display or an alarm of a scheduled program. As a result of determination, if the notification is displayed on the screen, the display apparatus lights at least a part of the bezel in operation S1902. In this regard, a position of the lighted bezel may be adjacent to, for example, a notification display position.

In operation S1903, the display apparatus determines whether a status of the displayed notification is changed. As a result of determination, if the status of the notification is changed, the display apparatus changes the lighting of the bezel in operation S1904. For example, as shown in FIGS. 12A and 12B, when the notification includes a time until the scheduled program starts, the time is reduced, and thus the area of the lighting bezel may be reduced.

FIG. 20 is a block diagram of the display apparatus 100 according to an exemplary embodiment. Referring to FIG. 20, the display apparatus 100 according to an exemplary embodiment may include the bezel 110, the display unit 120, a control unit 130, a storage unit 140, and a user interface unit 150. The display unit 120 may include the screen display area 121a and the bezel lighting area 121b.

The bezel 110 and the display unit 120 among the elements included in the display apparatus 100 are the same as described with reference to FIGS. 2 though 3b above, and thus detailed descriptions thereof are omitted.

The control unit 130 controls operations of all elements included in the display apparatus 100, and in particular, controls lighting of the bezel 110 to provide visual feedback corresponding to a status of the display apparatus 100. Detailed embodiments in which the lighting of the bezel 110 is controlled according to the status of the display apparatus 100 are the same as described with reference to FIGS. 5A through 15B.

The storage unit 140 may store an operating program for operating the display apparatus 100, content for reproduction, etc., in particular, lighting patterns of the bezel 110 corresponding to various statuses of the display apparatus 100. Thus, the control unit 130 checks the status of the display apparatus 100 and checks a lighting pattern of the bezel 110 corresponding to the checked status through the storage unit 140, thereby controlling lighting of the bezel 110.

The user interface unit 150 is used to receive a user input in the display apparatus 100 and includes a manipulation button or a touch screen.

As described above, according to the one or more of the above embodiments of the present inventive concept, a bezel of a display apparatus such as a TV is capable of outputting light, and lighting of the bezel is controlled according to a preset pattern of a status of the display apparatus, thereby providing a user with visual feedback.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present inventive concept have been described with reference to the figures, it will be understood by those of ordinary skill in the art that various changes in form and details may be made therein without departing from the spirit and scope of the present inventive concept as defined by the following claims.

1. A display apparatus, comprising:
a display unit configured to display a screen;
a bezel formed along a boundary of the display unit and configured to output light; and
a control unit configured to control lighting of the bezel,
wherein the control unit is further configured to control a lighting area of the bezel to provide visual feedback corresponding to a status of the display apparatus to a user.

2. The display apparatus of claim 1, wherein the control unit is further configured to provide the visual feedback to the user by controlling the bezel to partially or wholly output light according to a preset pattern corresponding to each of various statuses of the display apparatus.

3. The display apparatus of claim 2, wherein the control unit is further configured to control the lighting of the bezel via a graphic user interface (GUI) displayed on the display unit or a user input received by the display apparatus.

4. The display apparatus of claim 1, wherein the control unit is further configured to control the bezel to output light in at least a part thereof when the display apparatus is in a standby mode and to extend the lighting area of the bezel if the display apparatus is powered on.

5. The display apparatus of claim 1, wherein if content of a content list on a GUI displayed on the display unit is selected, the control unit is further configured to control the bezel to output light at a position corresponding to the selected content.

6. The display apparatus of claim 5, wherein if the selected content extends to an entire of the display unit and thus reproduction thereof starts, the control unit is further configured to extend the lighting area of the bezel.

7. The display apparatus of claim 1, wherein if a notification is displayed on the display unit, the control unit is further configured to control the bezel to output light in at least a part thereof.

8. The display apparatus of claim 7, wherein the control unit is further configured to change the lighting of the bezel according to a status change of the displayed notification.

9. The display apparatus of claim 1, wherein the control unit is further configured to control the lighting of the bezel according to a search direction of a menu list on a GUI displayed on the display unit.

10. The display apparatus of claim 1, wherein when an additional service related to content displayed on the display unit is displayed on an auxiliary display apparatus connected to the display apparatus, the control unit is further configured to control corresponding areas of the bezel of the display apparatus and a bezel of the auxiliary display apparatus to output light.

11. The display apparatus of claim 1, wherein the display unit comprises:
a screen display area configured to generate light for a screen display; and
a bezel lighting area configured to generate light for the bezel,
wherein the bezel is formed of a transparent material and is configured to output light by reflecting and diffusing the light generated in the bezel lighting area.

12. A method of providing visual feedback via lighting of a bezel of a display apparatus, the method comprising:
checking a status of the display apparatus; and
controlling lighting of the bezel to provide the visual feedback corresponding to the checked status to a user.

13. The method of claim 12, wherein the controlling of the lighting of the bezel comprises: controlling the bezel to at least partially output light when the display apparatus is in a standby mode, and extending a lighting area of the bezel if the display apparatus is powered on.

14. The method of claim 12, wherein the controlling of the lighting of the bezel comprises: if content in a content list on a GUI displayed on the display unit is selected, controlling the bezel to output light at a position corresponding to the selected content.

15. A computer-readable recording medium having recorded thereon a program for executing the method of claim 12.
